(19) United States
(12) Patent Application Publication
(10) Pub. No.: US 2006/0047695 A1
(43) Pub. Date: Mar. 2, 2006

(54) Generation of dynamic web contents

(75) Inventors: Markus Erlmann, Nurnberg (DE); Thomas Talanis, Heroldsbach (DE); Frank Volkmann, Nurnberg (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/204,675

(22) Filed: Aug. 16, 2005

(30) Foreign Application Priority Data
Aug. 26, 2004 (DE) 10 2004 041 395.9

(51) Int. Cl. G06F 7/00

(52) U.S. Cl. 707/102

(57) ABSTRACT

The invention relates to a method and a device, and to an automation device for the dynamic generation of data prepared in a markup language and displayable with a web browser. In order to provide a web server for the dynamic generation of web pages, which web server requires as few resources as possible on the target machine, it is proposed that
with the aid of a first data processing unit (1) at least one executable program module is generated on the basis of at least one text file,
the program module is loaded into at least one second data processing unit (2) and
the program module is executed by the second data processing unit (2) for generating the data displayable with the web browser.

### CROSS REFERENCE TO RELATED APPLICATIONS

This application claims priority to the German application No. 10 2004 041 395.9, filed Aug. 26, 2004 and which is incorporated by reference herein in its entirety.

### FIELD OF INVENTION

The invention relates to a method and a device for generating data prepared in a markup language and displayable with a web browser.

### SUMMARY OF THE INVENTION

A method or a device of this type has applications for example in internet technologies in which web contents generated by a web server may be displayed by a client with the use of the web browser.

In automation engineering, Internet technologies such as HTTP are increasingly being used for the purpose of communicating with an automation device via the internet or intranet. An internet browser such as Microsoft Internet Explorer or Netscape may be used to achieve remote control or remote configuration of so-called embedded systems or embedded devices. The precondition for this is that the embedded systems or embedded devices have the use of a web server.

One problem with setting up a web server on an embedded device such as an automation device is due to the few resources offered by such a device for implementing the web server service.

DE 102 37 875 A1 proposes a device and a method with which a file directory structure within an XML file can very easily be represented and/or displayed using an Internet-compatible language, in particular XML, on automation devices which, on account of their few resources, are unable to create their own file directory structure, which XML file is then transferred to the automation device by file transmission, with the result that the automation device functions as a web server, thus allowing remote access. A file directory structure of this type allows objects present on the target system to be addressed.

For the dynamic generation of HTML and XML outputs of a web server, Sun Microsystems have developed JSP (Java Server Pages) technology. JSP technology enables Java code and specific JSP actions to be embedded into static content implemented in HTML or XML. The resulting Java server page may be converted into Java source code with the aid of a specific JSP compiler. This results in a so-called Java servlet which, using the Java compiler, is then converted into a byte code capable of running on the Java Virtual Machine (Java VM).

However, on account of the few resources made available by embedded devices such as automation devices, to date only static web contents can be provided by a web server on an embedded device. The implementation of JSP requires a large resources input, which an automation device naturally cannot provide.

The underlying object of the invention is to provide a web server for the dynamic generation of web pages, said web server requiring as few resources as possible on the target machine.

This object is achieved with a method for the dynamic generation of data prepared in a markup language and displayable with a web browser, in which;
with the aid of a first data processing unit, at least one executable program module is generated on the basis of at least one text file,
the program module is loaded into at least one second data processing unit, and
the program module of the second data processing unit is executed for generating the data displayable with a web browser.

The object is further achieved by means of a device for the dynamic generation of data prepared in a markup language and displayable with a web browser, having
at least one first data processing unit for generating at least one executable program module on the basis of at least one text file, and
at least one second data processing unit into which the program module is loadable and which is provided for generating the data displayable with the web browser.

This object is further achieved by an automation device having a data processing unit for storing and executing at least one executable program module generated outside the automation device, the program module being provided for the dynamic generation of data displayable with a web browser.

According to the invention, the generation of the dynamic web contents is shared between two data processing units. An executable program module is first of all generated on the first data processing unit. At least one parser, a generator and a compiler are present on the first data processing unit for this purpose, with which parser, generator and compiler the program module is generated from the text file containing the required source code. Since parser, generator and compiler generally require a relatively large memory capacity for their implementation, the first data processing unit must have correspondingly large resources.

Finally, dynamic web contents in the form of data displayable with the web browser are generated by executing the program module. According to the invention, it is proposed that the second data processing unit is provided for executing the program module. To this end, the program module is first of all loaded from the first data processing unit on to the second data processing unit. The program module is capable, on request, of dynamically generating a website prepared in a markup language, which website is displayable by a web browser. The second data processing unit therefore functions as a web server which is able to respond to clients' requests by returning a dynamically generated website.

Since the generation of the program module is provided on the first data processing unit, the second data processing unit need not provide any resources for the components parser, generator and compiler. The second data processing unit need only provide sufficient resources for the installation of a run-time environment necessary for executing the program module and for storing the compiled program module(s).

The low resource requirement of the second data processing unit is especially advantageous if the program module is loaded into an automation device which exhibits the second data processing unit. It is intrinsic to embedded devices such as automation devices that their resources for managing software components are very strictly limited. The inventive sharing of the processing generating the dynamic web contents between the first and the second data processing unit is therefore especially advantageous in the specific case of the second data processing unit being a component part of the automation device and thus having only few resources. In such an embodiment of the invention, an automation device having web server functionality and which is capable of producing dynamic web contents is thus made available for the first time.

In an advantageous embodiment of the method according to the invention, the markup language is XML- or SGML-based. Numerous markup languages have been defined on the basis of the XML (extensible markup language) or SGML (standard generalized markup language) standard, which markup languages are capable of describing data displayable with a web browser.

A very widespread language in which texts are prepared for the World Wide Web is HTML (Hypertext Markup Language). It is therefore advantageous for the markup language to be HTML-based. HTML is first of all defined on the SGML standard, and later redefined in the meta language XML.

In a further advantageous embodiment of the invention, the text file contains text fragments prepared in an object-orientated programming language, in particular Java. From these text fragments, source texts may be generated which, once compiled, dynamically generate HTML pages on the second data processing unit. In the case of program modules written in Java, these are also known as so-called Java servlets.

In addition to the Java code, the text file advantageously contains text fragments prepared in the markup language. For example, HTML fragments may already be present in the text file, which fragments form part of the data prepared in the markup language that are displayable with a web browser.

In such a case it is advantageous that only the text-file text fragments prepared in the object-orientated programming language are used to generate the program module. The text-file text fragments prepared in the markup language may be stored on the second data processing unit without compilation. This HTML component is also modifiable without regeneration, or substitutable on the second data processing unit. Thus e.g. the HTML data generated by the program module may be combined with various static HTML fragments stored on the second data processing unit, providing a further degree of freedom in the preparation of dynamic web contents for example with the use of an automation device.

In an advantageous embodiment of the invention, the text file is executed as a Java Server Page. Java Server Pages (JSP) is a technology which serves substantially for the simple dynamic generation of HTML outputs by a web server. In JSP, Java source code may be embedded in static HTML-based text.

Especially when using text fragments prepared in Java within the text file, the program module may be generated in the form of a machine-independent byte code. Since the programming language Java is platform-independent, Java programs are capable of running independently of the operating system used and the hardware of the second processing unit. The compiled Java program module comprises a byte code which requires a software-based run-time environment, a so-called Java Virtual Machine. The Java Virtual Machine is installed on the second data processing unit, in order to ensure execution of compiled Java servlets thereon.

In order to achieve a higher processing rate of the web server, however, the program module may also be generated in the form of a machine-dependent machine code. This must be done taking account of the hardware-technical and software-technical conditions of the second data processing unit.

The first data processing unit is advantageously designed as an engineering system. With the engineering system, the compiled program modules are already generated on the data processing unit during an engineering phase in particular of an automating system. Web content requirements with regard to the running time are then responded to exclusively by the second data processing unit. To this end, the program modules previously generated with the engineering system on the basis of the text file are executed with the second data processing unit. For this purpose, in the course of the engineering phase the program modules are loaded into the second data processing unit, which is, for example, a component of an automation device.

The invention is described in more detail below with reference to the exemplary embodiments shown in the figures.

### BRIEF DESCRIPTION OF THE DRAWINGS

FIG. 1 shows a networked configuration comprising a first data processing unit, an automation device with a second data processing unit, and further data processing units,

FIG. 2 shows a flow chart of a conventional method of generating dynamic web contents, and

FIG. 3 shows flow charts of an embodiment of the method according to the invention for generating dynamic web contents.

### DETAILED DESCRIPTION OF THE INVENTION

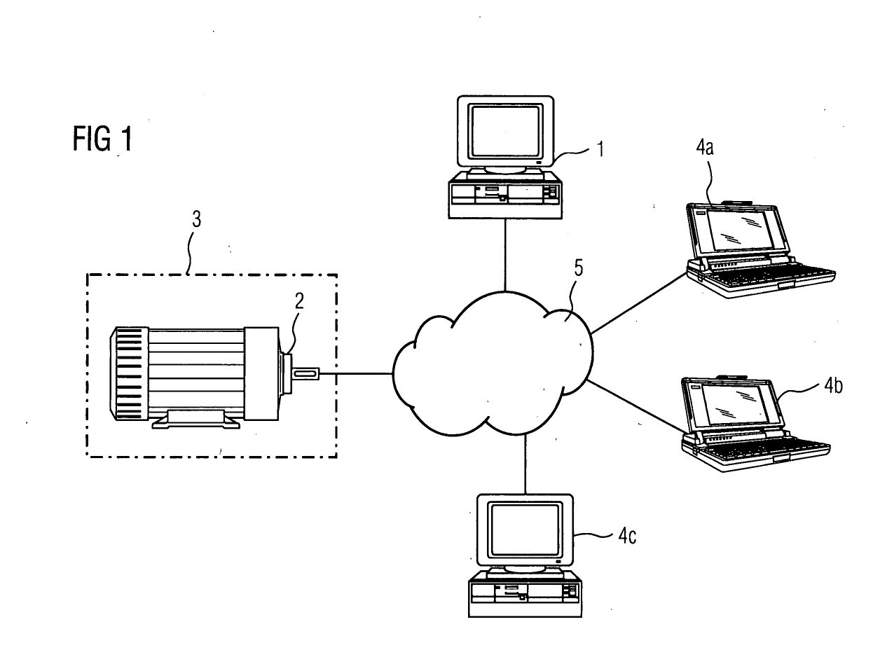

FIG. 1 shows a networked configuration comprising a first data processing unit 1, an automation device 3 with a second data processing unit 2, and further data processing units 4a, 4b, 4c. All data processing units 1, 2, 4a, 4b, 4c are linked via a computer network 5 which may be, for example, the Internet. This may, of course, be other manifestations of a computer network, such as an intranet.

The first data processing unit 1 is an engineering system with which compiled program modules are generated which may be used to generate dynamic web contents. In the case of JSP processing, the text file is, for example, a Java server page, and the program module a Java servlet. Via the Internet 5, the compiled Java servlets are loaded by the engineering system 1 on to the second data processing unit 2 connected to the automation device 3.

With the aid of the second data processing unit 2 and the loaded servlets, the automation device 3 is capable of functioning as a dynamic web server. Thus the further data processing units 4a, 4b, 4c, which in an industrial environment may be, for example, PCs or laptops, may communicate with the automation device via a Web browser such as Netscape or Internet Explorer. In the network shown, the further data processing units 4a, 4b, 4c thus operate as clients. In this way, a remote configuration of the automation device with clients 4a, 4b, 4c is thus enabled with the aid of the Internet.

By this means, a plurality of automation devices connected to the Internet may of course also serve as web servers, on to which Java servlets are loaded from a central engineering system or a plurality of engineering systems, which Java servlets enable a dynamic preparation of web contents.

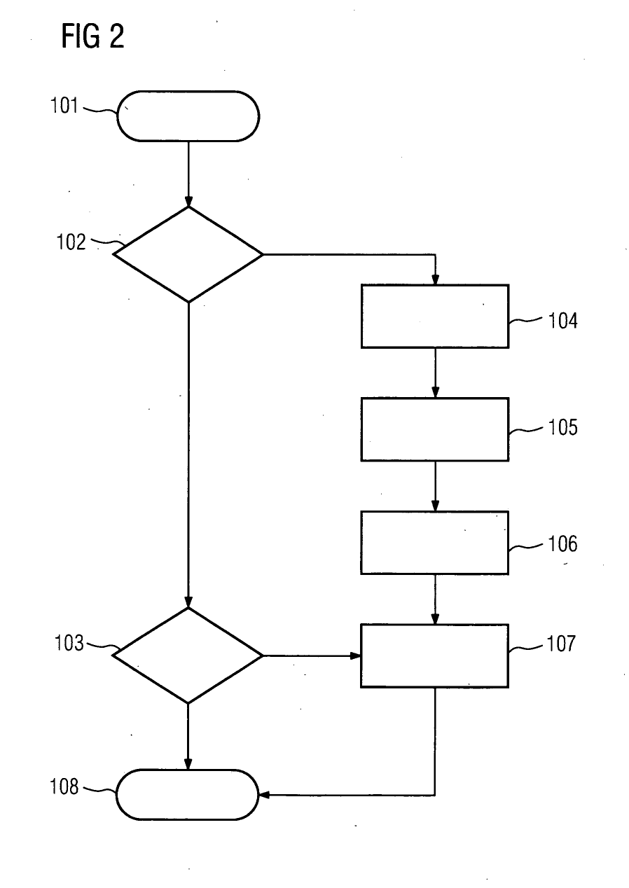

FIG. 2 shows a flow chart of a conventional method of generating dynamic web contents. It represents a JSP processing system within a data processing unit functioning as a web server.

The flow chart contains the following elements:
101: starting point: requesting of a JSP
102: branching: servlet present?
103: branching: servlet loaded?
104: JSP parsing
105: servlet code generation
106: servlet compilation
107: servlet loading
108: end point: return of an HTML page

Following the request for a Java Server Page (JSP) 101, in step 102 checks are first of all made to ascertain whether a corresponding Java servlet is present in the data processing unit. If this is the case, in the next step 103 it is checked whether the servlet is loaded for execution. If so, the servlet is executed and a corresponding HTML page is returned. This action represents the end point 108 of the flow chart. Otherwise, the required servlet is first of all loaded in step 107.

However, if in step 102 it is established that the required servlet is not present, branching is made to steps 104, 105, 106 and 107. In these steps, the JSP is first parsed 104, then the servlet source text is generated 105, and finally the servlet is compiled 106. In step 107, the compiled servlet is loaded for execution. By executing the servlet, the HTML page is returned 108.

In this method of generating dynamic web contents which is known from the prior art, parser, generator and compiler must be installed on the data processing unit serving as a web server. Accordingly, the data processing unit must offer sufficient resources for installing these components.

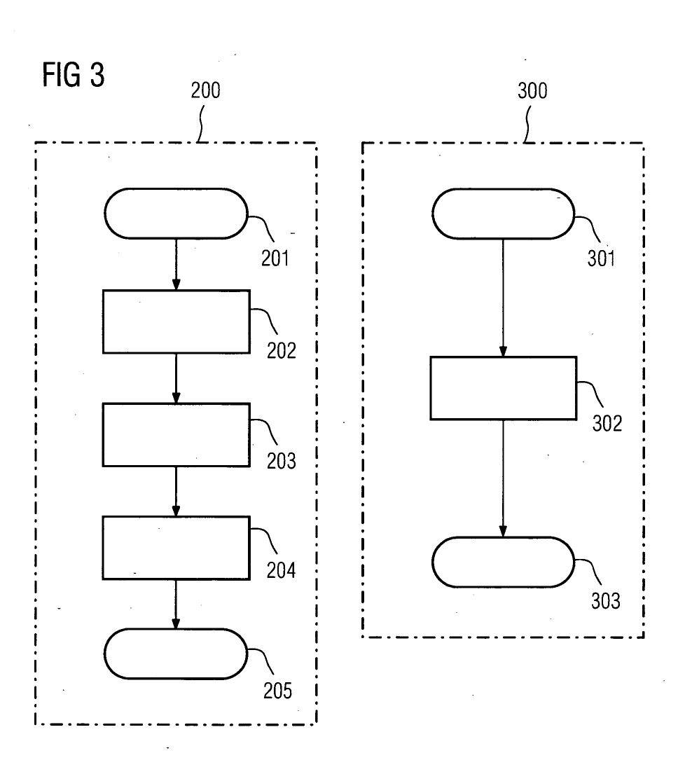

FIG. 3 shows flow charts of an embodiment of the method according to the invention of generating dynamic web contents on the basis of JSP processing. The method is subdivided into two phases, an engineering phase 200, which runs on a first data processing unit, and a processing phase to run time 300, which runs, for example, on a second data processing unit integrated in an automation device.

The first flow chart describing the engineering phase 200 contains the following elements:
201: starting point: generation of byte code
202: JSP parsing
203: servlet code generation
204: servlet compilation
205: end point: loading of byte code on to second data processing unit

During the engineering phase 200, one or more Java servlets are generated and compiled. To this end, one parser, one generator and one compiler must be installed on the first data processing unit. After parsing 202 of the JSP, the source code of the Java servlet is first of all generated. Following compilation 204 of the source code, a byte code is available which is finally loaded into the second data processing unit. This step marks the end point 205 of the engineering phase 200.

The processing phase at run time 300 contains the following elements:
301: starting point: requesting of a JSP
302: servlet loading
303: end point: return of an HTML page

The second data processing unit integrated into the automation device loads an already compiled Java servlet at the running time on request and, by executing the servlet, generates the requested HTML page. The automation device or second data processing unit thus operates as a Web server for generating dynamic web contents without requiring for this the resource-demanding installation of parser, generator and compiler for JSP processing. On the second data processing unit, only a Java Virtual Machine is necessary in order to be able to execute the byte code generated by the first data processing unit.

In addition to the Java servlets, HTML fragments can also be stored on the second data processing unit. These HTML fragments may also be modified on the second data processing unit. This is an additional possible means of influencing the output of the web contents, without requiring regeneration of the Java servlets.

The present invention is not to be limited to the embodiments shown here by way of example. Rather, further embodiments are conceivable and within the scope of the invention provided that the underlying concept, to share the generation of the program modules or servlets and their execution on at least two data processing units, is preserved. For example, the method according to the invention may also be used for generating dynamic web contents with the use of the Active Server Pages (ASP) technology developed by Microsoft in place of the JSP technology.

1-22. (canceled)

23. A method for a dynamic generation of data prepared in a markup language and displayable with a web browser, the method comprising:
generating an executable program module on the basis of at least one text file with the aid of a first data processing unit;
loading the executable program module into a second data processing unit; and
executing the executable program module by the second data processing unit for generating the data displayable with the web browser.

24. The method according to claim 23, wherein the program module is loaded into an automation device comprising the second data processing unit.

25. The method according to claim 23, wherein the markup language is XML-based or SGML-based or HTML-based.

26. The method according to claim 23, wherein the text file contains text fragments prepared in an object-oriented programming language.

27. The method according to claim 26, wherein the object-oriented programming language is Java.

28. The method according to claim 23, wherein the text file contains text fragments prepared in the markup language.

29. The method according to claim 23, wherein for generating the program module only such text fragments of the text-file are used which are prepared in an object-oriented programming language.

30. The method according to claim 23, wherein the text file is executed as a Java Server Page.

31. The method according to claim 23, wherein the program module is generated in form of a machine-independent byte code.

32. The method according to claim 23, wherein the program module is generated in form of a machine-dependent machine code.

33. A device for dynamically generating data provided in a markup language and displayable with a web browser, the device comprising:
at least one first data processing unit for generating at least one executable program module on the basis of at least one text file; and
at least one second data processing unit into which the program module is loadable and which is provided for generating the data displayable with the web browser.

34. The device according to claim 33, wherein the at least one second data processing unit is a part of an automation device.

35. The device according to claim 33, wherein the device is adapted to generate data prepared in an XML- and/or SGML-based markup language and/or in an HTML-based markup language.

36. The device according to claim 33, wherein the at least one first data processing unit is designed in such a way that the program module may be generated on the basis of a text file which contains text fragments provided in an object-oriented programming language.

37. The device according to claim 36, wherein the object-oriented programming language is Java.

38. The device according to claim 33, wherein the at least one first data processing unit is designed in such a way that the program module may be generated on the basis of a text file which contains text fragments provided in the markup language.

39. The device according to claim 33, wherein the at least one first data processing unit is adapted for generating the program module only on the basis of text fragments of the text-file which are provided in an object-oriented programming language.

40. The device according to claim 33, wherein the at least one first data processing unit is designed in such a way that the program module may be generated on the basis of a text file provided as a Java Server Page.

41. The device according to claim 33, wherein the at least one first data processing unit is designed in such a way that the program module may be generated in the form of a machine-independent byte code.

42. The device according to claim 33, wherein the at least one first data processing unit is designed in such a way that the program module may be generated in the form of a machine-dependent machine code.

43. The device according to claim 33, wherein the at least one first data processing unit is designed as an engineering system.

44. An automation device having a data processing unit for storing and executing at least one executable program module generated outside the automation device, wherein the program module is provided for the dynamic generation of data displayable with a web browser.
